(19) United States
(12) Patent Application Publication
(10) Pub. No.: US 2026/0075104 A1
(43) Pub. Date: Mar. 12, 2026

(54) TRANSMISSION OF FILES USING AN INTERMEDIATE STORAGE PROCESS

(71) Applicant: Siemens Mobility GmbH, München (DE)

(72) Inventor: Roland Porsch, Speichersdorf (DE)

(21) Appl. No.: 19/105,947

(22) PCT Filed: Aug. 16, 2023
(86) PCT No.: PCT/EP2023/072534

§ 371 Date: Feb. 24, 2025

(30) Foreign Application Priority Data
Aug. 24, 2022 (DE) 10 2022 208 766.6

(51) Int. Cl. H04L 67/06; G06F 16/182

(52) U.S. Cl. CPC H04L 67/06; G06F 16/182

(57) ABSTRACT

A method transmits a file from a communication participant of a first type to a plurality of communication participants of a second type. In the process, the file to be transmitted is transmitted from a communication participant of a first type to different storage devices arranged in a decentralized manner. Furthermore, at least one part of the file is transmitted from one of the aforementioned storage devices to one of the plurality of communication participants of the second type.

The invention relates to a method for transferring files and a communication system for carrying out the method. The invention further relates to a computer program and a computer-readable medium.

Network systems offer the great advantage that a plurality of participants can be granted access to the same data or files. In this way, the same files with the same content, for example relating to messages, advertising data, or up-dates, can be transferred to a large number of different recipients. However, such network systems come up against technical limits as the number of recipients and the size of the files increase. This becomes apparent, for example, in the case of file transfer between a land-side system and a plurality of vehicles. As the number of vehicles that are to receive the same file from the land-side system increases, the volume of data to be transferred also increases. However, the total transfer capacity is limited by a data transfer rate and possible limited data volumes in the case of communication via a mobile radio network. Therefore, an ever-increasing volume of data to be transferred leads to a risk of bottlenecks in data transfer and failures due to overload. This endangers operational safety as well as file transfer reliability.

The object of the invention is to improve the reliability of transferring a file from one communication participant to a plurality of communication participants.

This object is achieved with a method according to the features of claim 1. This object is additionally achieved by a communication system with the features of the independent system claim.

A further object of the invention is to provide a computer program and a computer-readable medium.

This object is achieved by a computer program according to the features of independent claim 14 and by a computer-readable medium according to the features of independent claim 15.

Further advantageous developments respectively constitute the subject matter of dependent claims.

The method according to the invention for transferring a file from a communication participant of a first type to a plurality of communication participants of a second type provides for the file to be transferred from a communication participant of the first type to various storage devices arranged in a decentralized manner. The method furthermore provides for at least a part of the stated file to be transferred from one of the stated storage devices to one of the plurality of communication participants of the second type.

In the present context, the stated storage device is a data storage means as defined in information technology. In particular, the data storage means is set up to have digital data written to it or read from it. For example, the storage device may be a solid-state memory or a flash memory. In a preferred embodiment, the stated storage device is part of a data processing device. This data processing device is preferably configured to store, read, write, transfer, and/or manage data. The data processing device may, for example, be a computer, a microcontroller, or a comparable programmable hardware component including the stated storage device.

In this way, it is possible to provide an efficient file transfer method. The storage devices can be used in the form of temporary storage means as multipliers for the transfer of the file. The data volume to be transferred by the communication participant of the first type can thus be reduced. In particular, the transfer of a file to the storage devices can be achieved at a low data transfer rate. Additionally, the files can be transferred independently of the availability of the communication participants of the second type. Furthermore, a high transfer speed between a storage device and a communication participant of the second type can be provided, which can be significantly increased, especially in comparison to a direct transfer of the files from the communication participant of the first type to a communication participant of the second type. Costly expansion of existing communication networks can thus simply be dispensed with.

One advantageous development provides that, for the purpose of transferring at least part of the file, a storage device is selected according to a parameter relating to the respective communication participant of the second type. The stated parameter may, for example, relate to a property or an operating state of the communication participant of the second type. This makes it possible to further improve file transfer efficiency. Furthermore, it is thus possible to provide an easily adaptable method.

A further advantageous development provides that at least one of the stated storage devices is selected for the purpose of transferring the file according to an item of location information of the communication participant of the second type. On the basis of the location information as a parameter relating to the communication participant of the second type, particularly rapid transfer of a file can be enabled. For example, the file can be downloaded on the basis of the location information from a storage device that has the shortest distance to the communication participant of the second type. This makes it possible to achieve transfer that is both fast and reliable. It is furthermore possible, for example, to avoid roaming charges by not transferring files across national borders.

One advantageous development furthermore provides that at least one of the stated storage devices is selected for the purpose of transferring the file according to an event plan of the communication participant of the second type. In the present context, the stated event plan is understood to be a plan in which tasks, operating states, or other events concerning a communication participant of the second type are described depending on a schedule. Such an event plan can be, for example, a timetable, a maintenance plan, or an inspection plan. With the assistance of the event plan, simple and reliable transfer of the file can be planned cost-effectively. In particular, this makes it possible in a straightforward manner to preferably utilize advantageous locations and relatively long idle times for the purpose of transferring the files. File transfer while the communication participant of the second type is in motion can thus be advantageously avoided.

Another advantageous development provides that information regarding storage locations of the stated files is transferred to each of the plurality of communication participants of the second type. The information may, for example, be a list of URLs or GPS location data of the storage devices. This makes it possible for communication participants of the second type, being aware of their own parameters, to decide when and from which storage device the file should be downloaded.

One advantageous variant embodiment provides that, in addition to the stated information relating to storage locations of the file to be transferred, a request for the purpose of downloading the file is transferred to the communication participant of the second type. In this way, it is possible to enable simple and cost-effective adaptation of existing communication protocols and/or communication protocols specified by standards. In particular, this enables straightforward and reliable application of standard IEC 61375, which contains specifications for the purpose of downloading files to vehicles.

A further advantageous development proposes that the file to be transferred be transferred to predetermined ones of the various storage devices arranged in a decentralized manner according to one of this file's attributes. The stated file attribute may be, for example, a type of content, a number of data records, a number of data records per data record type, a file creator, a file origin, a file size, a predetermined recipient group, a priority or a predetermined file type. The stated type of file content may be, for example, advertising data, media data, process data, service data, maintenance data, communication data, timetable data, vehicle data, or log data. In this way, it is possible to provide a file transfer method that is adaptable in a versatile and cost-effective manner. Available storage space can be put to efficient use by selectively distributing the files depending on their properties. In particular, it is possible to dispense with distributing all the files to be transferred to all the storage devices in a blanket manner.

An advantageous development furthermore provides transfer of a plurality of files from the communication participant of the first type to the plurality of communication participants of the second type. At least one of the plurality of files to be transferred is selected for the purpose of transfer to the various storage devices arranged in a decentralized manner according to at least one of this file's attributes. The stated file attribute may in particular be such an attribute as has already been described in the preceding context. The efficiency of the method can be further increased in this way. On the basis of a file's attribute, it can thus be decided whether this file is to be temporarily stored on various storage devices and then transferred to the communication participants of the second type or whether a direct transfer of predetermined files is to be made between the communication participant of the first type and one or more communication participants of the second type.

One advantageous variant embodiment provides that at least one of the plurality of files to be transferred is transferred to storage devices arranged in a decentralized manner according to file size. File transfer can be further optimized in this manner. It is conceivable for those files that exceed a minimum size to be transferred to storage devices. For example, files with a high priority and small file size can be transferred directly between the communication participant of the first type and one or more communication participants of the second type. If, on the other hand, the file size exceeds a limit value, for example, and is possibly also intended for a large recipient group, a decision can be made to perform the transfer indirectly with the assistance of the storage devices.

An advantageous development furthermore provides for the file to be transferred to be split into data blocks. The stated data blocks are furthermore transferred to the various storage devices arranged in a decentralized manner. It is conceivable for all the data blocks or only part of the data blocks to be distributed to the various storage devices arranged in a decentralized manner. The data blocks are preferably transferred according to a parameter relating to the communication participant of the second type and/or according to attributes of the split file. The stated parameter is in particular one of the previously described type. This enables flexible control of file transfer. The transfer method is thus appropriately adaptable to differing requirements. For example, this makes it possible to transfer at least part of the file despite a relatively short duration or low transfer speed.

The method according to the invention can be carried out using the communication system according to the invention.

The communication system according to the invention has a communication participant of the first type and a plurality of communication participants of the second type. Furthermore, the communication system according to the invention has a data processing system with a plurality of storage devices arranged in a distributed manner. The stated storage devices are in particular storage devices of the type previously described in the context of the method according to the invention. The stated storage devices are furthermore connected to the communication participant of the first type by way of a network connection. A file is furthermore transferable from the communication participant of the first type to at least one of the plurality of communication participants of the second type by way of the various storage devices.

Reliable and operationally robust file transfer can be achieved in this way. Furthermore, a data transfer speed and a data volume to be transferred by way of the stated network connection between the communication participant of the first type and the storage devices can accordingly be kept low.

An advantageous development of the communication system provides that the communication participant of the first type takes the form of a stationary communication participant. In particular, the communication participant of the first type takes the form of a stationary server. The communication participant of the first type is preferably what is known as a “land-side” participant, forming a stationary contact for mobile communication participants. In this way, the load on a central server can be reduced in a straightforward and reliable manner. Central server resources can either be reduced or used for alternative tasks.

An advantageous development of the communication system furthermore provides that at least one communication participant of the second type takes the form of a mobile communication participant. At least one communication participant of the second type preferably takes the form of a vehicle. At least one communication participant of the second type particularly preferably takes the form of a rail-borne vehicle. It is furthermore conceivable for all the communication participants of the second type to take the form of mobile communication participants, in particular of rail-borne vehicles. In this way, common problems in mobile data transfer, such as for example dropped connections or low data transfer rates in mobile radio networks, can be overcome in a straightforward and cost-effective manner. Reliable and cost-effective file transfer can furthermore be enabled in this way.

One advantageous development of the communication system furthermore provides that the stated storage devices are arranged along a specified route of the at least one mobile communication participant. Storage devices are, for example, arranged at stopping points, maintenance depots and/or a switchyard. This makes it possible to provide and utilize a high transmission quality at the intended locations of the mobile communication participant. In particular, data loss or inefficient use of the available data volume, for example due to dropped connections, can be avoided in this way. It is furthermore conceivable for storage devices to be arranged at predetermined distances along the stated route.

The invention furthermore provides a computer program which comprises commands which, on execution of the computer program by a data processing device, cause the communication system according to the invention to carry out the method according to the invention. The stated data processing device in particular comprises the previously described data processing device.

The invention furthermore provides a computer-readable medium including instructions which, on execution thereof by a data processing device, cause the communication system according to the invention to carry out the method according to the invention. The stated data processing device in particular comprises the previously described data processing device. The computer-readable medium may be, for example, a CD-ROM, a DVD, a USB or flash memory or a non-physical medium, such as a data stream and/or a data carrier signal.

The above-described characteristics, features and advantages of the invention and the manner in which they are achieved are explained in further detail in conjunction with the figures in the following description of the embodiments of the invention. Where appropriate, the same reference signs are used in the figures for the same or corresponding elements of the invention. The exemplary embodiment and described variants thereof serve to explain the invention and do not limit the invention to the combinations of features stated therein, not even in respect of functional features. In addition, all the features stated in the exemplary embodiment can be considered in isolation and suitably combined with the features of any desired claim.

### IN THE FIGURES

FIG. 1 shows a schematic illustration of an example of a method for transferring a file from a land-side participant to a plurality of vehicles;

FIG. 2 shows an exemplary embodiment of a communication system, by way of which the example of the method illustrated in FIG. 1 can be carried out.

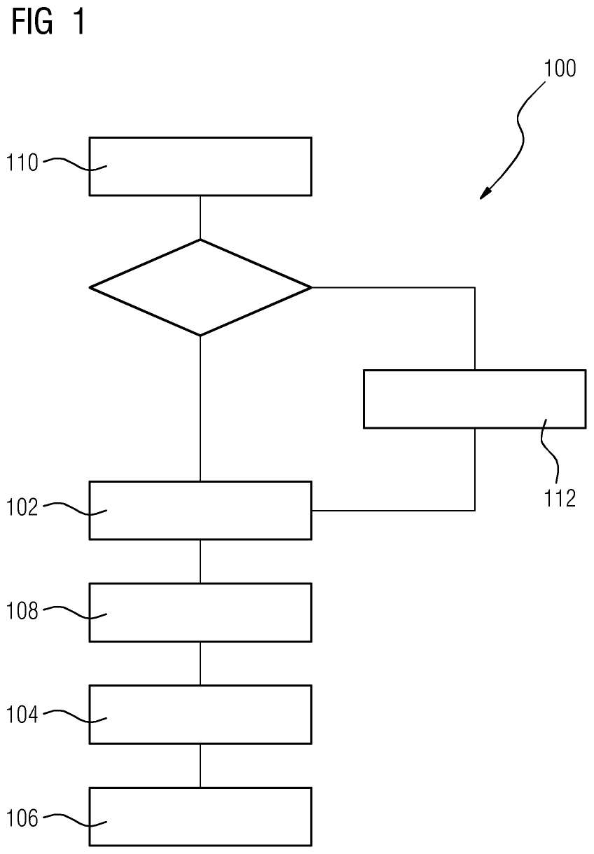

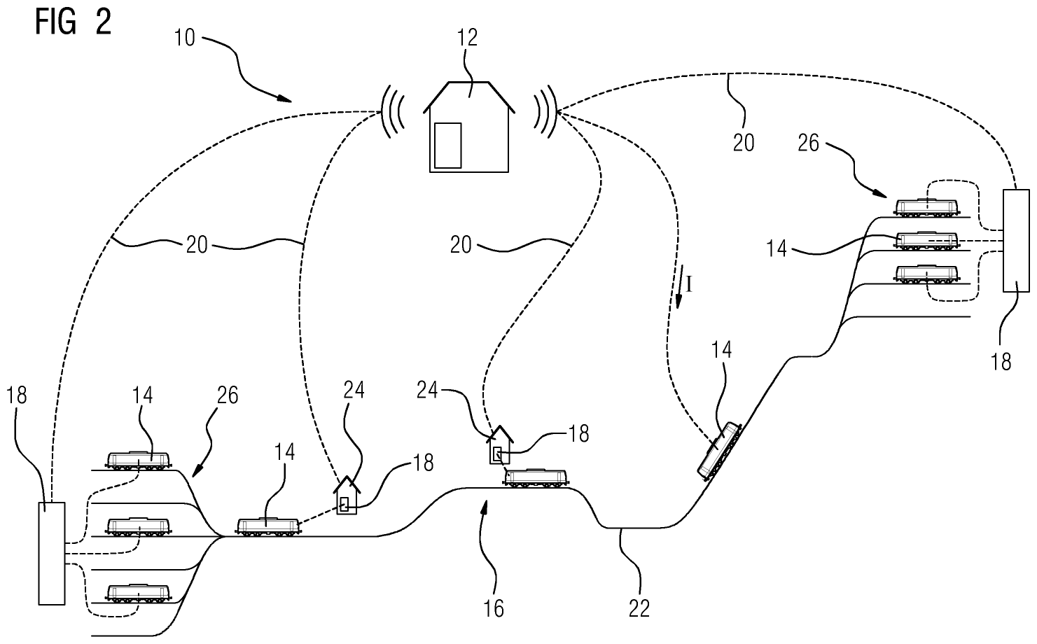

FIG. 1 shows a flow chart of an exemplary method 100 for transferring a file from a land-side participant 12 to a plurality of rail-borne vehicles 14. Both the land-side participant 12 and the vehicles 14 are depicted by way of example in FIG. 2. Various types of files, relating to process data, maintenance data or media data for example, are conventionally transferred between the land-side participant 12 and the vehicles 14. In the example of the method 100 currently being described, files are selected 110 according to an attribute of these files from the plurality of files to be transferred for the purpose of transfer to various storage devices 18 arranged in a decentralized manner. Such an attribute may relate inter alia to a type of content, or a file type or priority.

In the present exemplary embodiment, a file to be transferred is, for example, selected 110 according to an associated file size. As soon as a file to be transferred exceeds a first file size limit, it is transferred 102 to the stated storage devices 18 arranged in a decentralized manner. In the context of the example of the method 100 currently being described, other files can be transferred directly from the land-side participant 12 to the individual vehicles 14. The present example of the method 100 furthermore provides that the file selected in this way 110 is transferred 102 to just selected ones of the stated storage devices 18 according to a further attribute of this file. A type of file content is, for example, selected as the attribute. If the selected file relates to maintenance data or inspection data, this file is transferred 102 only to storage devices 18 that are arranged in a maintenance depot 26. It is alternatively or additionally conceivable for such a further attribute to relate to an intended recipient group or a file priority and for the file to be transferred 102 to storage devices 18 at predetermined locations in accordance with this attribute. A file can accordingly, for example, be distributed just to a specified customer group.

The method 100 illustrated by way of example in connection with FIG. 1 additionally provides that the file is split 112 into data blocks as soon as its size exceeds a second limit value. For the purpose of transferring the file, all the data blocks are transferred 102 to the various storage devices 18 arranged in a decentralized manner, in particular in accordance with one of the above-stated methods. In an alternative approach, it is conceivable for part of the data blocks to be transferred 102 to various ones of the storage devices 18 in order to make efficient use of possibly limited storage space. Both the stated storage devices 18 and the stated maintenance depot 26 are depicted schematically by way of example in FIG. 2.

Furthermore, information I relating to storage locations of the file to be transferred and/or its data blocks is sent 108 to each of the vehicles 14. This information I includes, by way of example, a list of URLs with the assistance of which an assignment of a storage location to a storage device 18 is described. In addition, a prompt to download 106 the file from at least one of the stated storage devices 18 associated with the stated storage locations is sent 108 to the vehicles 14 together with the stated information I. On the basis of knowledge of the storage locations, each vehicle 14 selects 104 one of the various storage devices 18 for the purpose of downloading 106 at least part of the file according to a parameter relating to the particular vehicle 14. In the example of the method 100 currently being described, the storage device 18 is selected 104 primarily according to an item of location information together with the information I from a maintenance plan for the vehicles 14. The stated location information is, for example, information I according to a GPS signal. It may alternatively or additionally also be location information determined on the basis of sensors or IP addresses. With the assistance of the location information, it is for example possible to select 104 a storage location 33 of the file to be transferred in such a way that this location is at the least distance from the vehicle 14 in question. In addition, it can be established on the basis of a maintenance plan whether an extended layover is intended. If this is the case, a plurality of files to be transferred can be reliably downloaded 106 at a high data transfer rate from a storage device 18 arranged in a maintenance depot 26 on arrival at the maintenance depot 26. In addition, selection 104 of a storage device 18 determined by the location of a vehicle 14 makes it possible to avoid roaming charges by file download 106 from the selected 104 storage device 18 only being permitted within predetermined national borders.

FIG. 2 shows a schematic representation of an exemplary embodiment of a communication system 10. This communication system 10 includes, by way of example, the above-stated plurality of rail-borne vehicles 14 and the land-side participant 12 including the stationary server. The exemplary embodiment of the communication system 10 furthermore includes a data processing system 16. This data processing system 16 includes the previously stated storage devices 18 arranged in a decentralized manner. Each storage device 18 is, by way of example, part of a data processing device arranged at the same location. Each of the stated storage devices 18 arranged in a decentralized manner is furthermore connected by way of a network connection 20 to the land-side participant 12 for the purpose of transferring a file or associated data blocks. In addition, the plurality of storage devices 18 arranged in a decentralized manner are set up to transfer a file from the land-side participant 12 to at least one of the vehicles 14.

FIG. 2 furthermore shows by way of example that the stated storage devices 18 are arranged along an intended route 22 which is traveled, by way of example, by a plurality of vehicles. Storage devices 18 are, by way of example, arranged at stopping points 24 and in maintenance depots 26. It is furthermore conceivable for further storage devices 18 to be arranged distributed in a manner not shown in greater detail at predetermined distances along the route 22.

The communications system 10 described by way of example in connection with FIG. 2 is in particular used to carry out the example of the method 100 described in connection with FIG. 1.

Although the invention has been illustrated and described in greater detail with reference to the preferred embodiments, the invention is not limited by the disclosed examples and other variations may be derived therefrom by a person skilled in the art without going beyond the scope of protection of the invention.

1-15. (canceled)

16. A method for transferring a file from a communication participant of a first type to a plurality of communication participants of a second type, which comprises the steps of:
transferring the file to be transferred from the communication participant of the first type to various storage devices disposed in a decentralized manner; and
transferring at least part of the file from one of the various storage devices to one of the plurality of communication participants of the second type.

17. The method according to claim 16, wherein, for a purpose of transferring the at least part of the file, a storage device of the various storage devices is selected according to a parameter relating to a particular said communication participant of the second type.

18. The method according to claim 16, wherein at least one of the various storage devices is selected for a purpose of transferring the file according to an item of location information of the communication participant of the second type.

19. The method according to claim 16, wherein at least one of the various storage devices is selected for a purpose of transferring the file according to an event plan of the communication participant of the second type.

20. The method according to claim 16, which further comprises transmitting information regarding storage locations of the file to the plurality of communication participants of the second type.

21. The method according to claim 16, which further comprises transferring the file to be transferred to predetermined ones of the various storage devices disposed in the decentralized manner according to one attribute of the file.

22. The method according to claim 16, which further comprises:
transferring a plurality of files from the communication participant of the first type to the plurality of communication participants of the second type; and
selecting at least one of the plurality of files to be transferred for a purpose of transfer to the various storage devices disposed in the decentralized manner according to at least one attribute of a selected file.

23. The method according to claim 22, which further comprises transferring at least one of the plurality of files to be transferred to the various storage devices disposed in the decentralized manner according to a file size.

24. The method according to claim 16, which further comprises:
splitting the file to be transferred into data blocks; and
transferring the data blocks to the various storage devices disposed in the decentralized manner.

25. A communication system, comprising:
a communication participant of a first type;
a plurality of communication participants of a second type; and
data processing system with a plurality of storage devices disposed in a decentralized manner and are connected in each case by way of a network connection to said communication participant of said first type and by way of which a file is in each case transferable from said communication participant of said first type to at least one of said plurality of communication participants of said second type.

26. The communication system according to claim 25, wherein said communication participant of said first type takes a form of a stationary communication participant.

27. The communication system according to claim 25, wherein at least one communication participant of said second type takes a form of a mobile communication participant.

28. The communication system according to claim 27, wherein said plurality of storage devices are disposed along a specified route of said at least one mobile communication participant of said second type.

29. The communication system according to claim 26, wherein said stationary communication participant is a stationary server.

30. The communication system according to claim 27, wherein said mobile communication participant is of a vehicle.

31. The communication system according to claim 30, wherein the vehicle is a rail-borne vehicle.

32. A non-transitory computer program having computer executable instructions which, when executed on a communication system performs the method according to claim 16.

33. A non-transitory computer-readable medium having computer executable instructions which cause a communication system to perform a method for transferring a file from a communication participant of a first type to a plurality of communication participants of a second type, which comprises the steps of:
transferring the file to be transferred from the communication participant of the first type to various storage devices disposed in a decentralized manner in the communication system; and
transferring at least part of the file from one of the various storage devices to one of the plurality of communication participants of the second type.
